(19) United States
(12) Patent Application Publication
(10) Pub. No.: US 2018/0350227 A1
(43) Pub. Date: Dec. 6, 2018

(54) SENSOR DEVICE HAVING SPECTRUM MONITORING

(71) Applicant: Tive, Inc., Cambridge, MA (US)

(72) Inventor: Krenar Komoni, Worcester, MA (US)

(73) Assignee: Tive, Inc., Cambridge, MA (US)

(21) Appl. No.: 16/039,913

(22) Filed: Jul. 19, 2018

Related U.S. Application Data
(63) Continuation-in-part of application No. 15/383,762, filed on Dec. 19, 2016.
(60) Provisional application No. 62/269,090, filed on Dec. 17, 2015.

(51) Int. Cl. G08C 17/02; H04W 16/14; H04W 4/80; H04W 74/08; H04W 8/00; H04W 24/10

(52) U.S. Cl. CPC G08C 17/02; H04W 16/14; H04W 4/80; H04W 84/12; H04W 8/005; H04W 24/10; H04W 74/0808

(57) ABSTRACT

Methods and apparatus for transitioning sensor devices to a signal collection mode for receiving and storing signal information for given frequencies and locations and transmitting the stored signal information to a remote site. The transmitted signal information can be processed to generate a spectrum map based upon the transmitted signal information. In embodiments, the transmitted signal information can be processed to identify signal anomalies.

### CROSS REFERENCE TO RELATED APPLICATION

The present application is a CIP of U.S. patent application Ser. No. 15/383,762, filed on Dec. 19, 2016, which claims priority from U.S. Provisional Patent Application No. 62/269,090 filed on Dec. 17, 2015, entitled “MULTI SENSOR DEVICE WITH CONNECTIVITY AND SENSING AS A SERVICE PLATFORM AND WEB APPLICATION,” all of which are hereby incorporated by reference.

### BACKGROUND

As is known in the art, sensors can include various components such as temperature, humidity, accelerometers, gyroscopes, magnetometers, and others. Such sensors can be used to collect data which can be processed.

### BRIEF DESCRIPTION OF THE DRAWINGS

FIG. 1A is a perspective view of an exemplary electronic sensor device having selective signal transmission shut off in accordance with one or more embodiments.

FIG. 1B is an exploded view of the FIG. 1A device.

FIG. 1C is a further exploded view of the FIG. 1A device.

FIG. 1D is a further perspective view of the FIG. 1A device.

FIG. 1E is a perspective view of another exemplary electronic sensor device having selective signal transmission shut off in accordance with one or more embodiments.

FIG. 2 illustrates an exemplary asset tracking process using a sensing device.

FIG. 3 illustrates an exemplary tracking application using a sensor device.

FIG. 4 illustrates an exemplary mesh-network configuration for multiple sensing devices.

FIG. 5 is a block diagram illustrating an exemplary cloud-based architecture for accepting and sending data to sensing devices.

FIG. 6 is a block diagram illustrating an exemplary cloud-based architecture for processing data that is obtained by a sensing device and data from external API calls.

FIG. 7 illustrates an exemplary connection of a sensing device to the cloud through a combination of WPAN, WLAN, and/or WWAN enabled wireless communication.

FIG. 8 is a block diagram illustrating components of an exemplary sensing device.

FIG. 9A is a schematic representation of a system having spectrum monitoring.

FIG. 9B is s graphical representation of received signal power information.

FIG. 9C is a schematic representation of mobile devices connected to a base station.

FIG. 10 is a schematic representation of a system that can collect and process signal information.

FIG. 11 is a schematic representation of a system for processing signal information to detect anomalies and/or generate spectrum maps.

FIG. 12 is an illustrative sequence of steps for collecting and processing signal spectrum information.

FIG. 13 is an example representation of a spectrum map from data transmitted by sensor devices.

FIG. 14 is a block diagram of an example computer that can perform at least a portion of the processing described herein.

### DETAILED DESCRIPTION

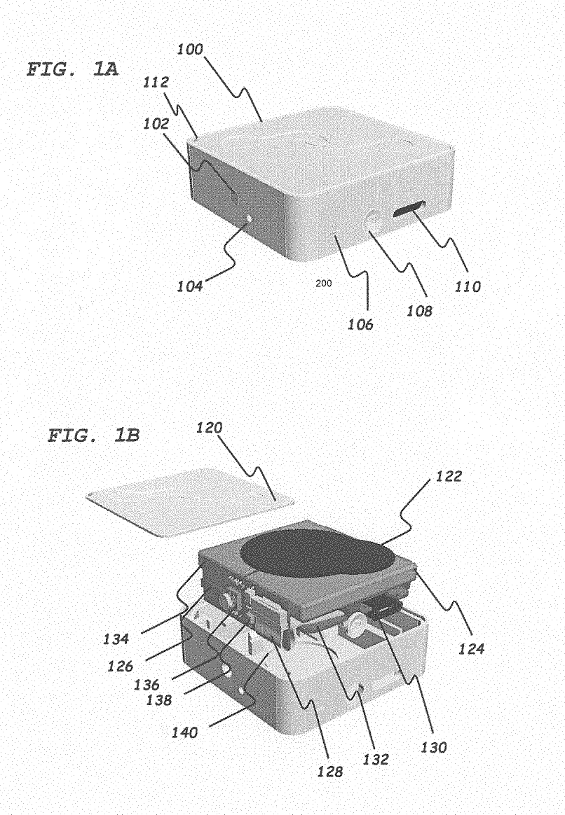

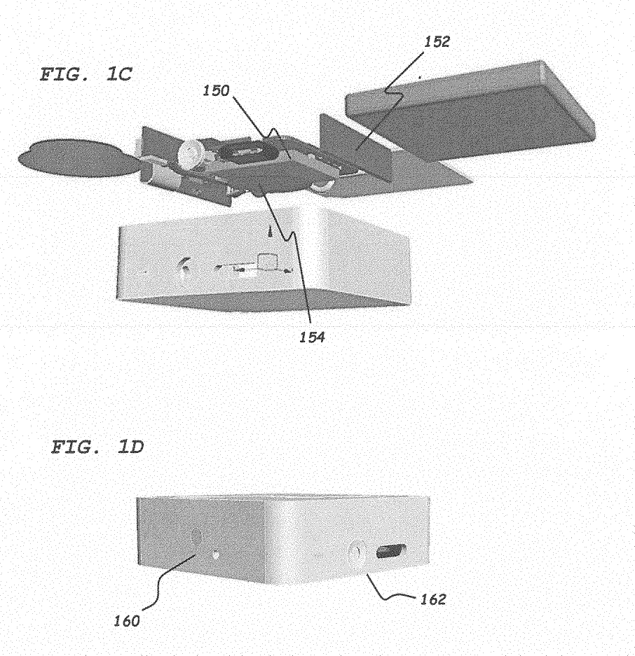

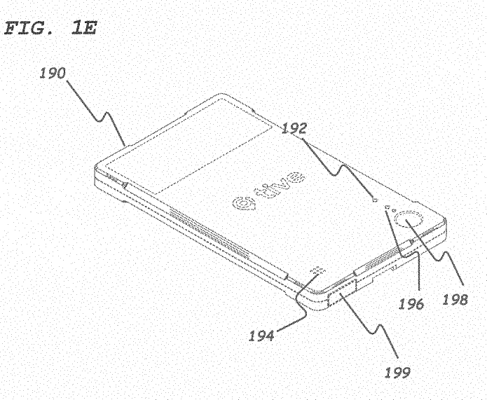

FIGS. 1A-1E illustrate an exemplary multi sensor electronic device 100 that can collect and transmit sensor data that can be processed to identify anomalies and/or generate spectrum maps.

FIG. 1A illustrates an exemplary multi sensor electronic device 100 in accordance with one or more embodiments. The device 100 has an outer case with a power button 108, which is used to turn on and off the device 100. The power button 108 can also be used to check the battery life of the device by pressing the button for a short time (e.g., less than a second). In one or more embodiments, a single multi-color (red, green, and blue) LED light 102 is used to indicate the status and the states of the device. The functionalities that the notification LED 102 can show include: battery power, cellular connectivity, GPS/GNSS connectivity, WPAN/WLAN/WWAN connectivity, various malfunctions, an OK (all good) status, and other features of the device. The blinking of the LED 102 and its colors can be programmed to indicate these features and various other notifications. The power button 108 pushing sequence and pushing length can also be programmed such that these various states of the device can be checked, or device actions can be performed.

In embodiments, the type C USB port (or other port such as, e.g., a mini or micro USB port) 110 is a multi-function port that can be used for one or more of the following: (1) for charging the battery, (2) to connect an external battery and extend the operation of the device, (3) to power the device where the LED 106 would light up, (4) to configure the device and update the firmware, and/or (5) to send other data such as sensor data through USB 110. This USB can also be utilized to communicate using other protocols with an adapter for UART/SPI/I2C or others and then sending data using those other protocols. In addition, the USB port can be used to connect two or more devices together so that they can share data between their sensors, processors, and/or their modules and utilize each other's wireless communication capabilities.

In embodiments, there are multiple sensors placed on the device. In some embodiments, sensors are provided for sensing of environmental conditions, ambient light, and/or infrared light. In order to perform these functions, the device utilizes sensors that measure: temperature, humidity, air pressure, acceleration, rotation, motion, and/or light, and they could be internal to the device or external sensors that communicate with the device using wireless communications such as BLE, WiFi, ZigBee, or other proprietary or open standards available. In one embodiment, an opening window 104 is provided enabling air flow and light to enter the device case. The general-purpose hole or lanyard hole 112 can be used for attaching the device to keys, bags, cars, and other things.

FIG. 1E illustrates an exemplary multi sensor electronic device 190 in accordance with one or more embodiments. The device 190 has an outer case with a power button 198, which is used to turn on and off the device 190. The power button 198 can also be used to check the battery life of the device by pressing the button for a short time (e.g., less than a second). In one or more embodiments, a single multi-color (red, green, and blue) LED light 196 is used to indicate the status and the states of the device. The functionalities that the notification LED 196 can show include: battery power, cellular connectivity, GPS/GNSS connectivity, WPAN/WWAN connectivity, various malfunctions, an OK (all good) status, and other features of the device. The blinking of the LED 196 and its colors can be programmed to indicate these features and various other notifications. An opening window 192 is used for the light to enter the device case, and that is the location of a light sensor under the light-pipe that can be placed in that opening. The power button 198 pushing sequence and pushing length can also be programmed such that these various states of the device can be checked, or device actions can be performed.

In embodiments, the type C USB port (or other port such as, e.g., a mini or micro USB port) 199 is a multi-function port that can be used for one or more of the following: (1) for charging the battery, (2) to connect an external battery and extend the operation of the device, (3) to power the device where the LED 196 would light up, (4) to configure the device and update the firmware, and/or (5) to send other data such as sensor data through USB 199. This USB can also be utilized to communicate using other protocols with an adapter for UART/SPI/I2C or others and then sending data using those other protocols. In addition, the USB port can be used to connect two or more devices together so that they can share data between their sensors, processors, and/or their modules and utilize each other's wireless communication capabilities.

In embodiments, there are multiple sensors placed on the device. In some embodiments, sensors are provided for sensing of environmental conditions, ambient light, and/or infrared light. In order to perform these functions, the device utilizes sensors that measure: temperature, humidity, air pressure, acceleration, rotation, motion, and/or light, and they could be internal to the device or external sensors that communicate with the device using wireless communications such as BLE, WiFi, ZigBee, or other proprietary or open standards available. In one embodiment, an opening window 194 is provided enabling air flow and light to enter the device case.

FIG. 1B illustrates an exploded view of the electronic device 100 where various internal parts are shown in more detail. The case cover 120 includes a lanyard hole 112. The device includes a GPS/GNSS antenna 122, which can be a flexible omnidirectional antenna. The battery 124 is placed on the device and it could be smaller or larger than the one shown in the figure. The device can include a Bluetooth or WiFi antenna, which can be provided as a chip antenna 126. The type C USB connector 130 for recharging the battery can also be used to program the micro controller. In embodiments, the main PCB 132 and the side PCB 134 of the device are connected using a ribbon type cable 128. The side PCB 134 also contains a light sensor 136 and the temperature/humidity/pressure/volatile organic compound (VOC) sensor 138. The device includes an alarm buzzer placed in the circle shaped space 140. A double-sided tape or other adhesive can be used to attach the buzzer to the case such that it can cause vibrations and sound can be emitted out of the device.

FIG. 1C illustrates another angle of the device showing a 2G/3G/4G cellular antenna as a PCB antenna 152, the buzzer 154, and a cellular module 150. The antennas can be designed for world-wide coverage.

FIG. 1D shows the device from a perspective in which LED 160 and power button 162 are both visible. Power button 162 is used to switch the device on or off, check status, and push data to the cloud. Each of these actions may be accomplished by different inputs using the power button and results in an output from the LED 160, in the form of either red, green or blue light combination. Additional detail of an example sensor is shown and described in U.S. Patent Publication No. 2017/0208426, which is incorporated herein by reference.

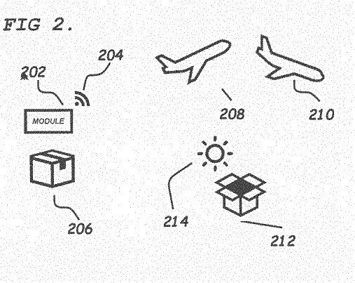

FIG. 2 shows an exemplary asset tracking application using a multi-sensor device 202 in accordance with one or more embodiments. The device is used to track and trace packages 206 during transportation in this example. In one embodiment, the multi-sensor device with wireless connectivity can be utilized to track/monitor the location, temperature, humidity, pressure, presence of VOCs, motion, handling, shock, and see if the package has been opened by interpreting data from an ambient light sensor or a proximity sensor. The update rates for each measurement can be modified remotely and can be programmed to connect to a network a selected number of times per period, where the period is some number of seconds, minutes, hours or days.

Tracking of the package can be visualized from its source to its destination. The pressure sensor and the accelerometer on the device can be used to determine the shipping method: ground or air. If the package is being transported by ground the pressure sensor will sense a certain range of pressure values that correspond with measurements of less than a few thousand feet above sea level and accelerometer readings that can correlate to accelerometer reading produced by an automobile, truck, or other means of ground transportation.

If the package is being transported by air, the pressure sensor will detect altitudes that are above 10,000 feet above sea level, for example, and sense accelerations within in a time period that can only be produced by an aircraft during takeoff 208 or landing 210. In embodiments, a sensor detects rate of change on air pressure inside a pressurized aircraft. If the pressure changes are greater than a selected number of Pascals per second that corresponds to the pressure changes inside a cabin of an aircraft. The other way would be to set a threshold so that when the pressure inside an aircraft is greater than a given number of Pascals (corresponding to a level at which aircrafts are usually normally pressurized to), and then turn off any radio transmission capabilities. In embodiments, a pressure sensor could detect the pressure inside an aircraft, which is usually pressurized between 11 and 12 psi, typically at 11.3 psi, when the aircraft is airborne above 10,000 feet, and then turn off any radio transmission capabilities. This mechanism can also be used to independently turn off all radios on the device to comply with FAA or other flight regulations. Additional embodiments that use accelerometer information for radio control are described below.

Turning off the radio causes the device to stop sending sensor measurement data to the cloud. However, the device continuously monitors the status of the package and stores the readings in its memory. An advantage of the device is that it has a memory that communicates to the micro-controller and it can store sensor data with timestamps during transportation of the package. Once connectivity conditions are met, the WWAN, WLAN, or WPAN radios are turned on to establish connectivity to the cloud and transfer the data based on the available wireless connections to the cloud.

Devices in accordance with various embodiments can be operated in various other configurations. For instance, in one example, the device can be configured to stay in sleep mode until there is a movement of the package detected by analyzing the accelerometer sensor data. Once the movement is detected the package can be tracked and traced continuously for a certain amount of time, or indefinitely until it runs out of battery power depending on the setup by the end user. This feature could allow the device to operate longer and save on its battery power. In another example, the device can be configured to be in sleep mode and only wake up once there is a change detected by the ambient light sensor, such as package being opened 212, or any other scenario where the ambient light sensor can change due to light 214 exposures.

In a further example, the device is configured to continuously track temperature or humidity and it can be setup to send an alert once a particular threshold is reached, enabling the safe and efficient transportation of items that are sensitive to temperature or humidity. In another example, the device is configured to monitor how the package has been handled by using the accelerometer sensor. For example, if a fragile package is thrown, tossed or moved in an undesired fashion during shipment, this data can be stored and reported back to the cloud. This can also apply for the orientation of the shipment as there are shipments that require particular orientation during transportation, such as refrigerators, stoves, server racks, and other appliances or electronics. The device can be attached inside the box used to transport these items and the orientation can be tracked and recorded in real-time.

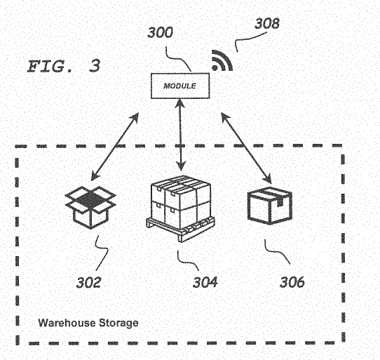

FIG. 3 illustrates an exemplary motion detection application in accordance with one or more embodiments. In this example, there are various items stored in a warehouse (location) 310 where they are supposed to be stored for multiple days or weeks and not be tampered with. For these types of applications, the device 300 can be placed inside a pallet 304, boxes 306, parcels 302, or other assets in a warehouse (other facilities). The device then can be programmed to stay in sleep mode until there is an actual motion detected by the accelerometer or gyroscope motion detector chipset. This motion can lead to the device waking up and sending a signal to the cloud and informing the end user that there has been tampering on the asset or item at which the device was placed in.

In another illustrative embodiment, the device 300 is placed in one of the assets shown below it: a package 302, a pallet 304, or any other asset 306. The assets are inside a warehouse, but they could be anywhere where tampering of the assets is not permitted for a certain period of time. In this case the device 300 is configured such that the majority of time is kept in sleep mode and once motion is detected it wakes up and utilizes the WPAN, WLAN, or WWAN connectivity 308 to send information to the cloud about the whereabouts of the device, using GPS/GNSS based location, cellular based location, WiFi based location and also send additional information regarding the motion detection due to tampering of the tracked device and the abrupt changes on the accelerometer or gyroscope readings.

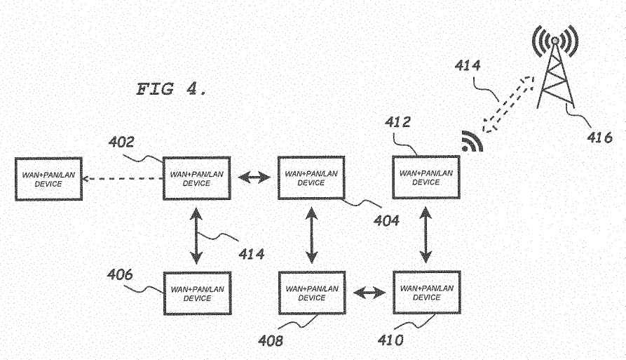

FIG. 4 shows an exemplary mesh network application in accordance with one or more embodiments with a combination of personal and Wireless Wide Area Network modules and chipsets. In one or more embodiments, a mesh network between the devices 402, 404, 406, 408, 410, and 412 is created using either USB connection or Wireless Personal Area Network (WPAN) connectivity such as Bluetooth, Bluetooth Low Energy, Bluetooth Smart, ZigBee, Z-Wave, or other low power wireless communication protocols. In this scenario, even though the devices (two or more) have WWAN 414 connectivity such as cellular, LoRa, Sigfox, or others, one of the devices is assigned to be the master (or designated device) to connect through WWAN 414 such as shown in FIG. 4 where only device 412 is connected to the WWAN.

In another embodiment the device containing WWAN+WPAN+WLAN, WWAN+WPAN, or WWAN+WLAN connectivity combinations could be utilized for reducing or minimizing power consumption. In one or more embodiments, six devices 402, 404, 406, 408, 410, 412 are shown. Initially, device 412 is connected to WWAN, and the device 412 will remain connected to the WWAN network for as long as the battery of the device reaches a certain percentage, such as 20%, 30% or any other percentage threshold. All the sensor readings from the other devices will be transferred to the WWAN connected device 412 through WPAN or WLAN through mesh or direct transfer method. Once that battery threshold is reached, the WWAN connectivity is turned off at the device 412 and WWAN of the next device 410 is utilized, and this continues with all other consecutive devices until the batteries of all devices are fully consumed as WWAN connectivity is a power-hungry connectivity method when compared with the other modules inside the electronic device. The data flow in this example goes from device 412 to 410 through WPAN or WLAN connection, and 410 then sends the received data to the cloud through its WWAN connectivity.

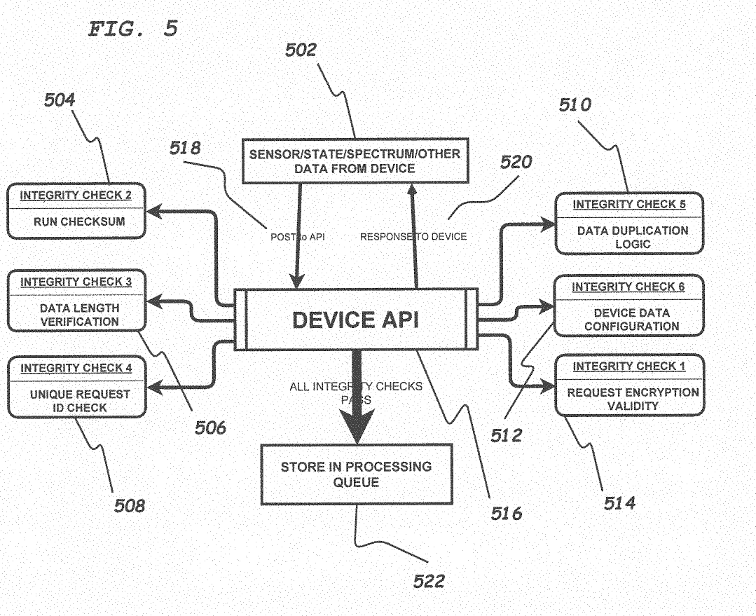

FIG. 5 illustrates an exemplary device and cloud architecture and how the data flows from the device to the actual database tables on the cloud. In one embodiment, the cloud platform could be custom, or it could utilize one of the well-known cloud platforms such as Google Cloud Platform, Amazon AWS, Microsoft Azure, or other custom backend platform. In another embodiment, the device 502 sends the sensor data, spectrum data, network characteristics data, and any other data available from the device such as Bluetooth network characteristics and any Bluetooth beacons that the device can sense around its area. There are multiple POST/GET methods that can be utilized to send the data to the server.

In another embodiment, the data is sent using the POST method 518 as an HTTP request to the server. As an underlying protocol, TCP, UDP, or other protocols can be utilized for communication to the cloud from the device. Once the Device API 516 receives the data it runs through multiple checks to validate that the data is coming from a real device, it has not been altered, and that the server is not being attacked with malicious hits. In order to read the data, the decryption 514 of the data is performed. The decryption happens using a key that is unique to the device. The keys are securely stored internally on the device and on the server and accessed only when decryption of the data occurs. After decryption, the integrity of the received and decrypted data string is double checked using a checksum 504 such as CRC16, CRC32, or others, if that passes, the length of the data 506 is verified. For each transaction, there is a unique request ID that is generated and checks if the request ID 508 is different from the last transaction. In order to mitigate Denial of Service (DoS) attacks, a duplication check 510 is performed to make sure that the same string is not being sent over and over again by an unauthorized client, where SSL is not utilized. In this case any duplicate data is ignored, this check most likely will not occur as it would have failed the unique request ID check 508. If the above checks pass, a last check 512 of confidence is performed to verify that the incoming data from the device correlates with the configuration of the device. For instance, if the data is being sent every minute and the device is configured to send every 15 minutes, this raises a flag. The device is then checked to make sure that the update rate is set to the client's desired update rate of every 15 minutes. Device API also communicates back to the actual device hardware with response such as SUCCESS of reception of data, and/or ERROR ###, where ### is an error number corresponding to an issue that the device has experienced. Upon successful checks, the device API also responds 520 to the device for “Successful Reception” of data or an error code showing the reason why the data reception failed. If there are any configuration changes on the device, those are also sent at this time. In addition to responding to the device, the device API sends all the verified data to a queue for further processing, computation and storage.

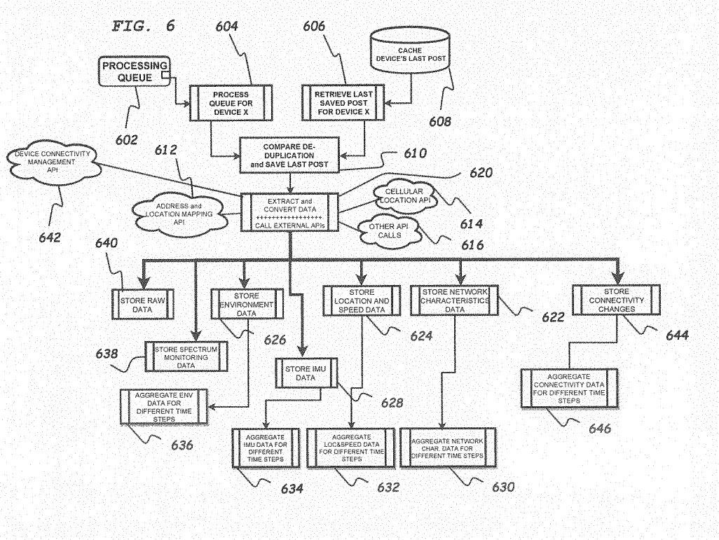

FIG. 6 illustrates an exemplary method in accordance with one or more embodiments of processing the data that has been placed in queue by the device API shown in FIG. 5. After the data has been Queued, a First-In-First-Out (FIFO) approach is implemented and scalability will be executed depending on the latency of the last queued message. As the latency increases, more resources are allocated to process 602 the queued data in parallel. Once the device message is retrieved 604 from the queue, another function also retrieves the last stored message for that particular device from cache 608. In order to minimize cellular data usage, duplicate data from device are ignored and only data that changed from the previous message are sent to cloud. This reduces data charges and creates a de-duplication algorithm from which the device operates in. In order to support this approach to data de-duplication, the API receiving the data requires an additional function 610, which compares the received message with the last cached message. The new data from the comparison then is saved in place of the last cached message. After this step, the data is extracted 620 into multiple fields using a JSON parser or a delimiter parser depending on the data format used during transmission, and each field will be stored in its appropriate data table 640 638 628 626 624 622 644. Prior to storing the data on tables, external APIs are called to extracted further data, such as street address and mapping points 612 from longitude and latitude data received from the device's GPS/GNSS. Another external API that is the cellular based location API (such as Combain, UnwiredLabs, OpenCellID, and/or others) 614 is called to obtain an approximate location based on the Local Area Code (LAC), Mobile Network Code (MNC), Mobile Country Code (MCC), and CellID information obtained from base-stations near the device, providing additional information on the location of the device if there is no GPS availability. Another external API that is the cellular based location API (such as Combain, Unwired Labs, Google, and/or others) 616 is called to obtain an approximate location based on WiFi SSID and RSSI values available in the proximity of the device. In addition to data related APIs, other APIs 616 such as WiOFi location or others could also be called to further enrich the raw data received from the device. Another example of additional APIs would be temperature, humidity, and pressure related API. Based on raw location data, outside temperature, pressure, and humidity can be obtained using an external API (such as Accuweather, Weather.Com, and/or others) and that data can be stored for future or immediate correlative comparison to determine whether the device is outdoors or indoors. In addition, device connectivity management APIs 642 are also utilized to observe connectivity session times, data usage, network carrier information, and others. These data points are then combined and stored into multiple tables. Raw data from the device is stored in a raw data table 640. Spectrum monitoring data is stored in a separate table 638, and all the environmental data are stored in table 626. An additional aggregation function is also performed on the environmental data in order to improve the performance and reduce latency at the end user application. This aggregated data is then stored in multiple tables 636 for various time steps. The same also occurs for the Inertial Measurement Unit (IMU) data 628 634, location and speed data 624 632, network characteristics data 622 630, connectivity related data 644 646, motion detection data and other data that goes into processing queue.

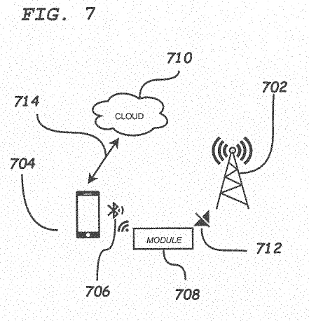

FIG. 7 shows the device connecting to cloud through another WPAN and WLAN/WWAN enabled device in accordance with one or more embodiments. In the illustrated example, the device is connected through WPAN 706 (Bluetooth Smart or BLE in this case, and others are possible) to a smartphone 704. The device transfers all the sensor readings and other data that it needs to send 714 to the cloud 710 to an app inside the smartphone 704 that connects to the device 708 directly through WPAN. This can occur when the device 708 is synchronized with a smartphone 704 through an app that recognizes the device 708 and it accepts data from the device and then sends it to the cloud 710 so that it can be consumed and utilized by a web application, smartphone app, desktop-based software, or other tool. In this case the device could lose the WWAN/WLAN based connectivity, as shown in 712, and connect to the smartphone 704 through its WPAN enabled connectivity to conserve energy and use a lower power solution such as Bluetooth 706 connection instead of the device's cellular connection 712 to indirectly connect to WWAN or a cell tower 702 as shown in one embodiment.

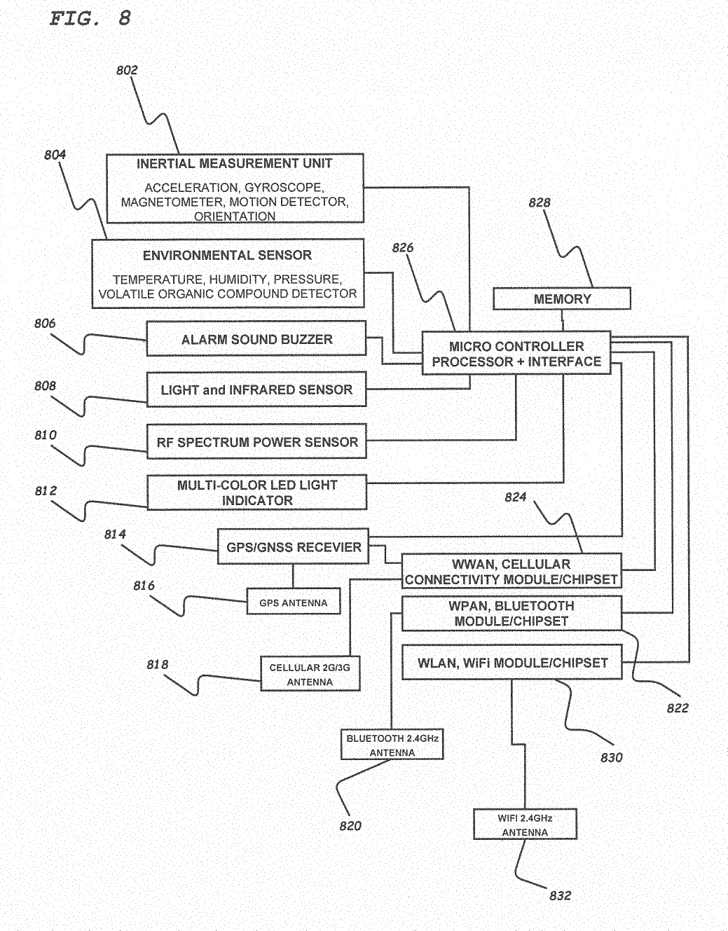

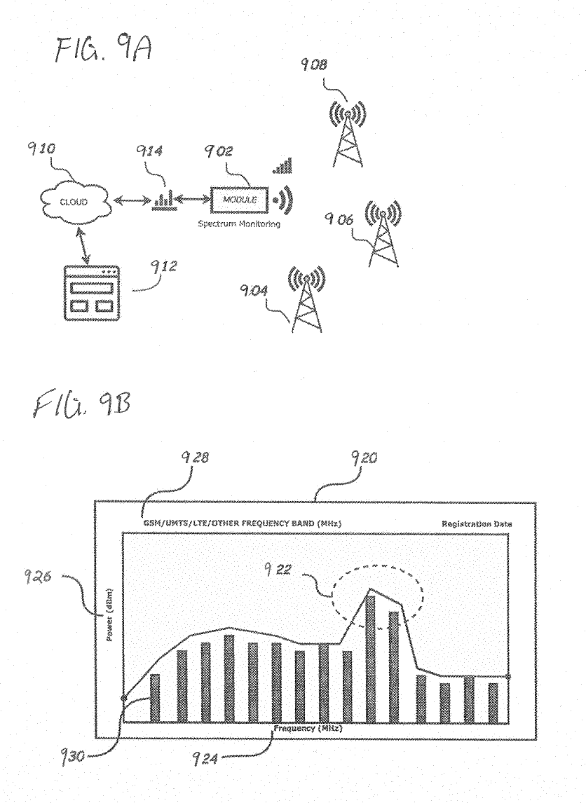

FIG. 8 is a block diagram illustrating components of a multi-sensor electronic device in accordance with one or more embodiments. The device includes a microcontroller (MCU) 826, such as STM32 which is an ARM based microcontroller, or any other microcontroller or microprocessor. The memory 828 is also connected to the MCU and the sensor data can be saved on the memory when the wireless connectivity is not available to send the data to the Internet. The device includes multiple sensors including, but not limited to: (1) inertial measurement unit (IMU) 802, which has an accelerometer, gyroscope, magnetometer, motion detector, and orientation output for the device, (2) environmental sensors, which are comprised of a temperature sensor, humidity sensor, pressure sensor, and volatile compound detector 804, (3) visible light and infrared sensor 808, (4) radio frequency (RF) spectrum power sensor 810 for various frequencies in the cellular bands. The device further includes GPS/GNSS receiver 814 to provide longitude, latitude, speed, and other information that is available from GPS/GNSS receivers. The device also includes alarm sound buzzer 806 used for finding the device or for any alerts or system information. The device also includes a multi-color LED indicator. The device further includes a WWAN cellular connectivity module 824 that can work in various standards (2G/3G/4G), various bands, and various modes of operation. The device also includes a WPAN Bluetooth module 822 that is used to communicate with other devices such as smartphones or other multi-sensor electronic device to form a mesh network. The device also includes a WLAN WiFi module 830 that is used to sense WiFi routers/access points, and possibly communicate through those routers if necessary. The device also includes antennas for GPS 816, cellular connectivity 818, WiFi 832, and Bluetooth 820. The cellular antenna could be changed to meet global cellular coverage requirements for 2G, 3G, 4G and 5G connectivity in the future.

The GPS/GNSS receiver 814 can be a separate receiver or incorporated inside the WWAN cellular connectivity module 824. The WPAN module 822 could also be a ZigBee, Z-Wave, 6LoWPAN, or any other personal area network module. The WWAN module could meet one or more or any combination of cellular standards such as: GSM, UMTS, CDMA, WCDMA, LTE, LTE-A, LTE-Catl, LTE-Cat0, LTE Cat-M1, NB-IoT, LTE-MTC, LoRa, Sigfox, and others. WWAN module 824 could also be a LoRA or a Sigfox module that connects to the non-cellular network focused of machine-to-machine (M2M) communications. WWAN module 824 can be any other module that functions in wide area using wireless means of communication.

In another aspect, embodiments of a sensor device can collect signal information at various frequency bands for testing purposes and transmit the information to a remote location for processing. For example, a sensor device can be placed in a test-mode for configuring the receive channels to record power levels at each band and store signal information.

As is known in the art, frequency bands have a specific Evolved-UTRA Absolute Radio Frequency No. (EARFCN) number that is allocated with that band. For instance, the EARFCN of 19200 is associated with frequency band 1710 MHz and 19201 is associated with frequency band 1710.1 MHz. These bands are available in test mode and can be swept through using cellular device modules, such as a sensor device.

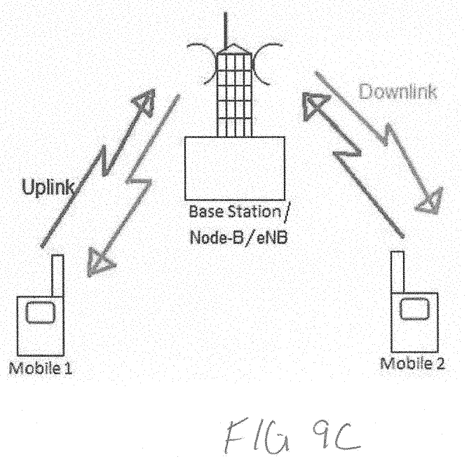

FIGS. 9A and 9B illustrate an exemplary spectrum monitoring application in accordance with one or more embodiments. The device 902 can be configured to measure the RF power across the 2G/3G or 4G bands. For instance, the device is configured to receive power measurements at each band and channel 914 of 2G (GSM or others) and 3G (UMTS or others) standards. Once the scanning is complete, each value then is stored in the microcontroller or processor of the device and the cellular connectivity module is restarted to transmit and connect to the cloud 910. The stored data is then sent to the cloud with power measurement readings at each band of the GSM and UMTS standards acting as a spectrum analyzer 912 for those bands 914. As shown in FIG. 9B, the same can also be applied to LTE bands and power at each channel can be reported through a spectrum dashboard 920. The spectrum analyzer dashboard can show frequency on the x-axis 924 and the detected power 930 at that band on the y-axis 926 in terms of dBm or other power metrics. Frequency region 922 shows where there are signals in channels in that band. If the detected power in the region 922 exceeds a certain power level and/or exceeds the certain power level for a given amount of time, an anomaly can be deemed to have occurred. The signal information associated with the anomaly can be stored and transmitted to a remote network for processing via the cloud.

FIG. 9C shows a first mobile device coupled to a base station with uplink and downlink channels and a second mobile device also coupled to the base station. The mobile devices can cycle through desired channels at selected time intervals to monitor received signal strengths.

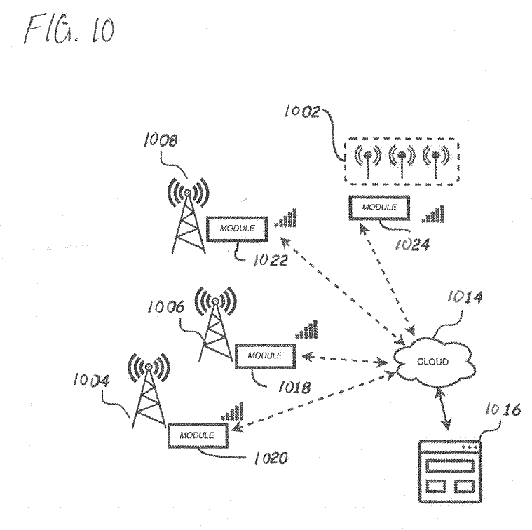

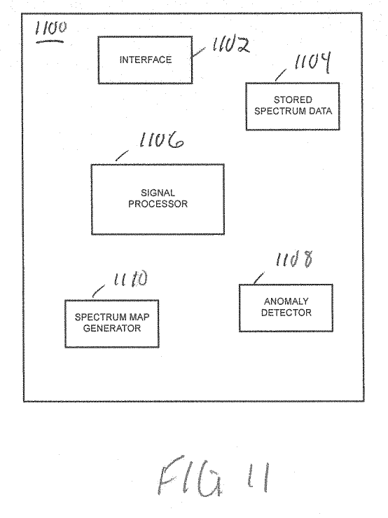

FIG. 10 shows an exemplary network diagnostic application in accordance with one or more embodiments at various locations and next to Distributed Antenna Systems (DAS) or Base Terminal Stations (BTS). In one embodiment multiple devices 1018, 1020, 1022, 1024 are placed next to various network BTS towers 1004, 1006, 1008 and also distributed antenna systems (DAS) 1002. The devices then perform spectrum analyses on various bands for GSM, UMTS, LTE, and other standards and send that data back to the cloud 1014. This monitoring allows a user to use a dashboard 1016 to review and manage spectrum of each BTS tower and DAS location. This enables a user to set threshold for spectrum power to make sure that unlicensed and unallocated signals do not suddenly appear in licensed bands. This spectrum monitoring dashboard may look similar to the dashboard 920 of FIG. 9B.

The Federal Communications Commission (FCC) is an agency of the United States government created by statute to regulate interstate communications by radio, television, wire, satellite, and cable. Each frequency band in United States belongs to a licensed or an unlicensed band, and each country has its own regulatory body. There are various bands in each country that are designated for cellular coverage. Certain frequency bands, such as 2.4 GHz and 5 GHz, are unlicensed where WiFi routers can operate freely. Licensed bands include GSM Bands 850, 900 and 1800 which cover the globe with cellular connectivity. It will be appreciated that monitoring these bands at a global level is expensive as one would need to place spectrum analyzers in every location where these licensed bands operate.

There has also been an increase in the number of so-called rogue cell-towers and stingrays which are difficult to detect without any type radio frequency power measurements. However, using spectrum monitoring together with mapping of frequency bands and their power emissions FCC and other interested parties could easily detect anomalies in locations where rogue towers and stingrays that are not permitted to operate.

In embodiments, sensor devices in shipping containers can monitor desired bands as the shipping containers travel throughout the globe. In embodiments, sensor devices can collect signal information to identify signal anomalies and/or generate a spectrum usage map. In embodiments, data from sensor devices in shipping containers routed all over the world can be aggregated and processed.

Table 1 shows example definitions for radio spectrum segments and Table 2 show example microwave band designations.

TABLE 1
STANDARD DEFINITIONS
OF RADIO SPECTRUM SEGMENTS

| | Frequency | |
|---|---|---|
| Name | range | Applications |
| Low frequency (LF) | 30 to 300 kHz | Navigation, time standards |
| Medium frequency (MF) | 300 kHz to 3 MHz | Morine/aircroft navigation, AM broadcast |
| High frequency (HF) | 3 to 30 MHz | AM broadcasting mobile radio, amateur |
| | | radio, shortwave broadcasting |
| Very high frequency (VHF) | 30 to 300 MHz | Land mobile, FM/TV broadcast, |
| | | amateur radio |
| Ultra high frequency (UHF) | 300 MHz to 3 GHz | Cellular phones, mobile radio, |
| | | wireless LAN, PAN |
| Super high frequency (SHF), | 3 to 30 GHz | Satellite, radar, backhaul, TV, |
| millimeter-wave range | | WLAN, 5G cellular |
| Extremely high frequency | 30 to 300 GHz | Satellite, radar, backhaul, |
| (EHF) | | experimental, 5G cellular |
| Terahertz, tremendously | 300 GHz to IR | R & D experimental |
| high frequency (THF) | | |
| or fat infrared (FIR) | | |

TABLE 2
MICROWAVE LETTER BAND DESIGNATIONS

| Band | Frequency range | Applications |
|---|---|---|
| L | 1 to 2 GHz | Satellite, navigation (GPS, etc.), cellular |
| | | phones |
| S | 2 to 4 GHz | Satellite, SiriusXM radio, unlicensed |
| | | (Wi-Fi, Bluetooth, etc.), cellular phones |
| C | 4 to 8 GHz | Satellite, microwave relay, Wi-Fi, DSRC |
| X | 8 to 12 GHz | Radar |
| Kᵤ | 12 to 18 GHz | Satellite TV, police radar |
| K | 18 to 26.5 GHz | Microwave backhaul |
| Kₒ | 26.5 to 40 GHz | Microwave backhaul, 5G cellular |
| Q | 30 to 50 GHz | Microwave backhaul, 5G cellular |
| U | 40 to 60 GHz | Experimental, radar |
| V | 50 to 75 GHz | New WLAN, 802.11ad/WiGig |
| E | 60 to 90 GHz | Microwave backhaul |
| W | 75 to 110 GHz | Automotive radar |
| F | 90 to 140 GHz | Experimental, radar |
| D | 110 to 170 GHz | Experimental, radar |

Table 3 below shows example GSM band information.

GSM frequency bands

| | f | Uplink (MHz) | Downlink (MHz) | Channel | Equivalent | Regional |
|---|---|---|---|---|---|---|
| GSM band ♦ | (MHz) ♦ | (mobile to base) ♦ | (base to mobile) ♦ | numbers ♦ | LTE band ♦ | deployments ♦ |
| T-GSM-380^{[a]} | 380 | 380.2-389.8 | 390.2-399.8 | dynamic | ? | None |
| T-GSM-410^{[a]} | 410 | 410.2-419.8 | 420.2-429.8 | dynamic | ? | None |
| GSM-450 | 450 | 450.6-457.6 | 460.6-467.6 | 259-293 | 31 | None |
| GSM-480 | 480 | 479.0-486.0 | 489.0-496.0 | 306-340 | ? | None |
| GSM-710 | 710 | 698.2-716.2 | 728.2-746.2 | dynamic | 12 | None |
| GSM-750 | 750 | 777.2-792.2 | 747.2-762.2 | 438-511 | ? | None |
| T-GSM-810^{[a]} | 810 | 806.2-821.2 | 851.2-866.2 | dynamic | 27 | None |
| GSM-850 | 850 | 824.2-848.8 | 869.2-893.8 | 128-251 | 5 | CALA,^{[b]} |
| | | | | | | NAR^{[c]} |
| P-GSM-900^{[d]} | 900 | 890.0-915.0 | 935.0-960.0 | 1-124 | ? | None |
| E-GSM-900^{[e]} | 900 | 880.0-915.0 | 925.0-960.0 | 0-124, | 8 | APAC,^{[f]} |
| | | | | 975-1023 | | EMEA^{[g]} |
| R-GSM-900^{[h]} | 900 | 876.0-915.0 | 921.0-960.0 | 0-124, | ? | None |
| | | | | 955-1023 | | |
| T-GSM-900^{[a]} | 900 | 870.4-876.0 | 915.4-921.0 | dynamic | ? | None |
| DCS-1800^{[i]} | 1800 | 1710.2-1784.8 | 1805.2-1879.8 | 512-885 | 3 | APAC,^{[f]} |
| | | | | | | EMEA^{[g]} |
| PCS-1900^{[j]} | 1900 | 1850.2-1909.8 | 1930.2-1989.8 | 512-810 | 2 | CALA,^{[b]} |
| | | | | | | NAR^{[c]} |

When radio frequency equipment is used it is usually transmitted at an allowable transmit power that is regulated by the FCC and other bodies. As an example, in US the output power of a device at 2.4 GHz cannot exceed Effective Radiated Power of 1 mW (0.001 W) and the transmitter must have a valid FCC Part 15 Reg ID.

In embodiments, a sensor device, which can be in or on a shipping container, can have spectrum monitoring capability for detecting signal powers that are higher than usual for excessive periods of time, which can be flagged. Once the spectrum scan is performed on the sensor device, the collected signal spectrum data can be sent to the cloud during times of connectivity. In embodiments, machine learning modules can be trained to detect signal anomalies. In embodiments, a sensor device can detect and store signal anomalies and report the anomalies to the FCC, for example, when FCC regulations may be an issue.

In some embodiments, a system can process the signal spectrum data collected from various devices, such as sensor devices in shipping containers, in trucks, in packages, and other items. Some of these sensor devices could be stationary, and some of them could be mobile. Processing can be performed to identify usage increases and decreases on particular locations on various bands, and/or other anomalies. For example, the spectrum data at times and locations can be used to monitor cell-sites from various providers, such as AT&T, T-MOBILE, VODAFONE, etc., to identify cell-sites being shut down, and/or brought up by monitoring cell-site downlink frequencies at various locations.

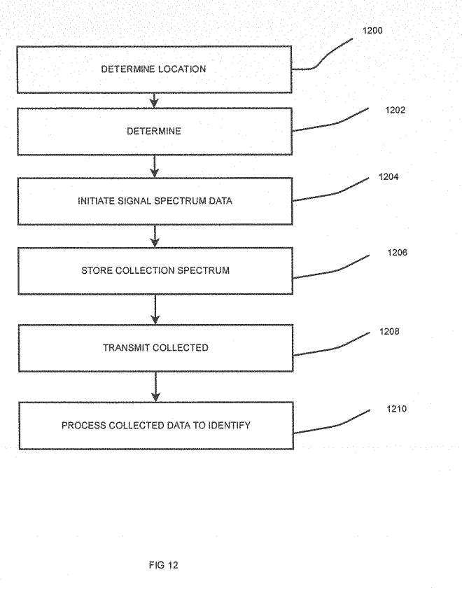

FIG. 11 shows an example node 100 having an interface 1102 to receive data transmitted by remote sensor devices that can be stored 1104. In embodiments, the stored data is for various frequencies, times, locations, networks, etc. The stored spectrum data 1104 can be processed by a signal processor module 1106. In embodiments, an anomaly detector 1108 processes data from the signal processor to identify signal anomalies. In embodiments, a spectrum map generator 1110 maps the spectrum data by location, for example, to provide a coverage map. In embodiments, the map can show signals by frequency and/or type of signal, cell, WiFi, etc.

In embodiments, a route for a given package with sensor device can be based upon the spectrum map. For example, a package having expensive or sensitive content may be routed in a particular way to maximize cloud connectivity. Based on spectrum monitoring and cloud connectivity on previous shipments, the shipping carrier route could be adjusted so that the moving asset would take routes through areas where cellular coverage is the best. In this way, the package contents can be monitored securely during the route.

FIG. 12 shows an example sequence of steps for collecting signal spectrum data to detect anomalies in accordance with illustrative embodiments. In step 1200, a sensor device determines a parameter, such as location, for collecting signal spectrum information. Example parameters include location, time, altitude, temperature, humidity, acceleration of the sensor device, wireless network detection, WiFi signals, Bluetooth signals, etc. In step 1202, the sensor device determines a current time, so that it has a timestamp that can be sent to the cloud for when the measurement took place. In embodiments, the sensor device is configured to collect signal spectrum data at certain times and/or locations. By collecting signal information at the same locations at various times, signal data can be averaged, for example, so that anomalies can be more easily identified at a particular location.

Based on the time/location, the sensor device can initiate collection of signal spectrum data in step 1204. As described above, the sensor device can collect signal data such as bandwidth and power at selected frequencies, which can be stored in step 1206. In step 1208, the sensor device can transmit the stored data. In embodiments, the sensor device transmits data when a wireless network is detected to ensure efficient transmission to a remote network via the cloud. In step 1210, the data collected at the remote site can be analyzed.

For example, if a particular cell site is operational 24-7 and is found to be missing at a particular time, the FCC, vendor, or other entity, can be notified. In another embodiment, a signal at a particular frequency at a certain location is found by a given sensor device to exceed an FCC threshold for some period of time, or some number of times by multiple sensor devices. Such information can be transmitted to a monitoring site, so that an appropriate action can be taken by interested parties.

It is understood that the term anomaly in the context of signal spectrum should be construed to include a wide variety of unknown and/or unexpected conditions. For example, anomalies can include the unexpected absence of a signal for one or more frequencies and/or bandwidths, the unexpected presence of a signal for one or more frequencies and/or bandwidths, the presence of a signal that exceeds certain parameters, such as FCC regulations on maximum allowable transmission power for unlicensed and licensed bands from an intentional radiator.

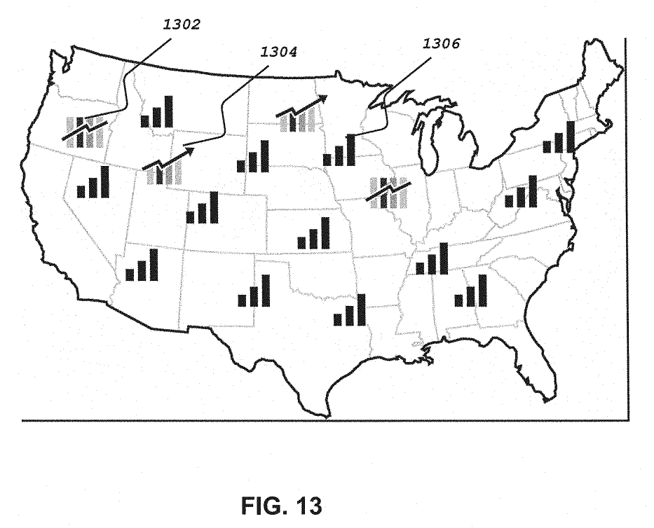

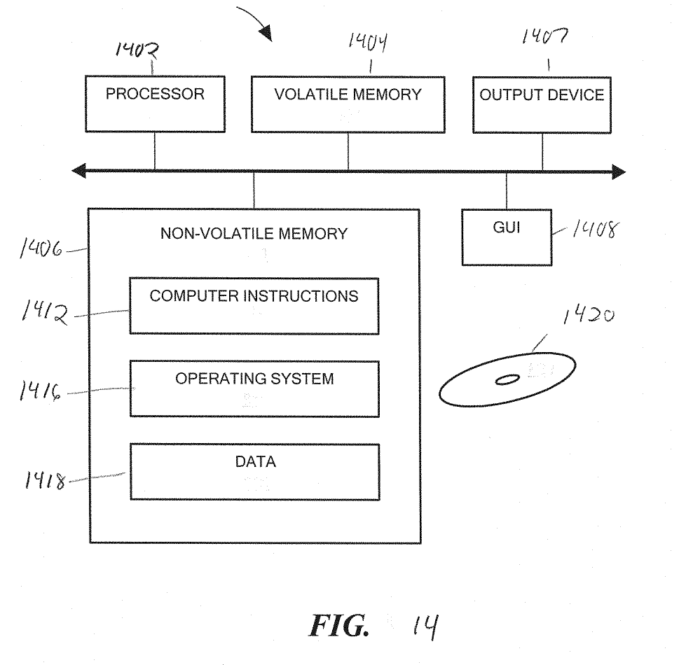

FIG. 13 shows an example of US signal spectrum map generated from data aggregated from sensor devices in shipping containers that have travelled all over the country. As noted above, at various times and locations for selected frequencies, received signal data is collected and transmitted to a remote site for processing. The collected data can be processed to map locations and signal spectrum data. For example, data can be collected at airports, along ground routes, ocean routes, in aircraft, in ships, in local delivery vehicles, at warehouses, and the like. In some instances, spectrum map data does not change 1306 over time and no anomalies are detected, and in some instances, there could be transmission output power increases 1304 that can be detected as anomalies at a particular period in time, and in some cases the transmission output power could disappear or go down 1302 and can also be detected as an anomaly.

While example embodiments are shown and described in conjunction with sensor devices that facilitate tracking of shipping containers and monitoring environmental conditions, it is understood that any suitable mobile device that can collect signal spectrum data can be used to meet the needs of a particular application without departing from the scope of the claimed invention.

Embodiments of the invention provide spectrum monitoring and/or signal anomaly detection for a variety of RF signals having characteristics, such as frequency band, bandwidth, power level (Watts or dBm), etc. Signals can be monitored continuously to enabling spectrum mapping over the country and world for understanding of licensed operators emitting a wide range of signals. In embodiments, the signal spectrum data collected by sensor devices can be sent to a remote site via the cloud for processing, such as signal averaging, threshold comparisons and other metrics to meet the needs of a particular application. Example signal anomalies that can be detected include sudden power emission increases in a particular frequency band or set of frequency. Bands, sudden power emission decreases in a particular frequency band or set of frequency bands, periodic detection of power increases and decreases, such as power being on for five minutes and then off for five minutes, detection of power increases on one or more frequency bands due to wideband signal jamming, detecting power spectrum changes on a particular location after a period of time of not being there and reporting the change, e.g., a sensor device that showed up at the same location again after a month.

In embodiments, a sensor device can separate code for spectrum monitoring that is not enabled by default, however, after the request made from the cloud the sensor device can turn on the spectrum monitoring. In addition, the spectrum monitoring can be a default state of the sensor device, and the cloud can command the device to monitor signals at a set interval, or monitor during certain periods of the day/night, or just listen and wait for a monitoring request from the cloud.

FIG. 14 shows an exemplary computer 1400 that can perform at least part of the processing described herein. The computer 1400 includes a processor 1402, a volatile memory 1404, a non-volatile memory 1406 (e.g., hard disk), an output device 1407 and a graphical user interface (GUI) 1408 (e.g., a mouse, a keyboard, a display, for example). The non-volatile memory 1406 stores computer instructions 1412, an operating system 1416 and data 1418. In one example, the computer instructions 1412 are executed by the processor 1402 out of volatile memory 1404. In one embodiment, an article 1420 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A method, comprising:
transitioning sensor devices to a signal collection mode for receiving and storing signal information for given frequencies and locations;
transmitting the stored signal information to a remote site;
processing the transmitted signal information to generate a spectrum map based upon the transmitted signal information.

2. The method according to claim 1, further including processing the transmitted signal information to identify signal anomalies.

3. The method according to claim 2, wherein the anomalies comprise a shut down cell site.

4. The method according to claim 1, wherein the sensor devices comprise devices having multiple sensors and wireless connectivity configured for placement on or in a good that is being shipped to collect data while the good is en route.
